(19) United States
(12) Patent Application Publication
(10) Pub. No.: US 2022/0193488 A1
(43) Pub. Date: Jun. 23, 2022

(54) EXERCISE ROLLERS

(71) Applicants: Qun Cai, Naperville, IL (US); Feng Tian, Naperville, IL (US)

(72) Inventors: Qun Cai, Naperville, IL (US); Feng Tian, Naperville, IL (US)

(21) Appl. No.: 17/207,642

(22) Filed: Mar. 20, 2021

Related U.S. Application Data
(60) Provisional application No. 63/128,056, filed on Dec. 19, 2020.

(51) Int. Cl. A63B 22/20; A61H 15/00; A63B 22/00; A63B 21/00

(52) U.S. Cl. CPC A63B 22/203; A61H 15/00; A63B 22/0025; A63B 21/4037; A63B 2210/50; A61H 2201/1261; A61H 2205/12; A63B 2022/0038; A63B 2208/0233; A61H 2015/0064

(57) ABSTRACT

Among others, the present invention provides exercise rollers each including two trays, each tray having an elongated track configured for receiving a roller element. Each roller element is movable along the corresponding track between its two ends, configured to enable a user to perform knee and leg exercise, and receive foot exercise, by moving the roller elements back and forth along the respective tracks.

### CROSS-REFERENCE TO RELATED APPLICATION

This application claims priority to U.S. Application No. 63/128,056, filed on Dec. 19, 2020, the contents of which are incorporated herein by reference in its entity.

### FIELD OF THE INVENTION

The present invention generally relates to the field of exercise and massage devices, and more specifically relates to exercise rollers with roller elements movable along corresponding tracks, for providing knee and leg exercise and/or foot massage.

### BACKGROUND OF THE INVENTION

Joints and muscles in the legs and feet are very important for various physical functions such as walking, stair climbing, and for balancing. Insufficient exercise to the legs and feet may cause concerns, such as venous thromboembolism, which occurs when red blood cells, fibrin and, to a lesser extent, platelets and leukocytes, form a mass (i.e., clot) within an intact vein. Veins in the legs, lie near and between muscles and contain valves that maintain the flow of blood in the direction of the heart by preventing backflow and stasis. The contraction of these muscles (e.g., through walking and exercising) forces the blood through the veins in the direction of the heart, usually against the force of gravity, thereby preventing blood from accumulating in the extremities. Individuals who are relatively immobile for long periods (e.g., at work, at home, during hospitalization, during pregnancy) are more likely to have swell lower limbs with stationary blood, as well as a higher risk of diseases like venous thromboembolism.

Moreover, joint injuries and diseases are commonly occurred in all people. For instance, patients with arthritis often suffer from red swelling, pain, high fever and intolerable pain at joint parts, which may develop to a late stage with joint stiffness, bone deformity, loss of a plurality of moving functions, even disabilities or paralysis. It is important for patients to properly exercise and move joints without causing pressure to further damage injured or diseased parts, and thus many conventional exercises (e.g., running) are not suitable for rehabilitation exercise. Thus, it is desired to have rehabilitative therapy devices and technologies for properly and conveniently exercising joints (e.g., knees)—to cause joint fluid to move around provide more nutrients to the joint, without creating harmful pressure to the joint.

In addition to exercise, massage has been used as a type of physical therapy for increasing blood flow, and treating and preventing varies diseases. In particular, foot massagers are popular, as they can stimulate acupuncture points on the soles to promote blood circulation and metabolism of the human body, thereby preventing fatigue recovery and various diseases. Conventional exercisers (e.g., pedal exerciser) and massagers (e.g., electrical foot massagers) typically provide either exercise or massage function—but not both. Additionally, many of the existing devices are very noisy, inflexible, complicated, unportable, expensive, or not durable. Further, some exercises or massages provided by the current tools are too intense, and thus are not comfortable or suitable for people (e.g., elderly or injured people) requiring more gentle care.

To overcome these drawbacks, it is therefore desired to have an improved exercise device for properly and conveniently exercising knees, legs and/or feet. It is also desired to have an exercise device to provide simultaneous foot massage during the exercise. Further, it is desired to have a simple, compact, less expensive, portable, and quiet tool capable of providing gentle and suitable exercise and massage to people in need.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The present invention generally relates to a novel type of exercise rollers with roller elements movable along two tracks, for properly and conveniently exercising joints (e.g., knees) and legs, while also providing appropriate and gentle foot massage at the same time. Particularly, the exercise roller according to the present invention allows a user to seat (e.g., in a chair or couch) and put his or her feet on top of the two roller elements, and then naturally move the legs back and forth, to move the roller elements along the responding tracks. Accordingly, the present invention provides great exercise to the user's knees, legs and feet by (a) causing joint fluid to move around and providing more nutrients to the joint, without causing harmful pressure to the joint; (b) strengthening muscles in the lower legs and feet to improve strength, flexibility and balance of the body; and (c) providing gentle massage to the feet during the exercise to promote blood circulation and metabolism of the body.

The present invention provides an exercise roller comprising two opposite, generally horizontal planar trays, each tray having a bottom surface and a top surface, the top surface of each tray comprising an elongated recessed area forming a track configured for closely receiving and maintaining a roller element, each track having two ends; and two roller elements, sized and configured to be independently and respectively movable along the two tracks between their respective ends. In particular, the size of the roller element and the length and width of the tray are configured to enable a user to perform knee exercise and receive foot massage while being seated, by using the user's two legs to move the roller elements, one by each foot, back and forth along the respective corresponding tracks.

In some embodiments, the two roller elements are identically sized.

In some embodiments, the roller element is a ball. For instance, such ball shaped roller element may have an ellipsoid or round shape.

In some embodiments, the roller element may have a hard and/or generally smooth (or non-smooth) surface. For instance, the smooth surface may provide gentle massage to the user's foot during the movement or exercise.

In some embodiments, the roller element is made of stone, wood, metal, or plastic. The roller element may be made of a single material.

In some embodiments, when the roller element is positioned onto or within the corresponding track, the highest point of the roller element is higher than the top surface of the tray, so as to enable the user's foot to contact part of the roller element above the top surface of the tray.

In some embodiments, the track has a curved or grooved inner surface. The track may have opposite curved, grooved, angled, or vertical side walls, and a generally horizontal bottom wall. In some further embodiments, the track has two opposite curved or angled upper side walls, respectively connecting to two opposite vertical lower side walls, connected by the horizontal bottom wall; wherein the upper side walls are configured to closely receive the roller element and enable the roller element to contact and move along the upper side walls without contacting the horizontal bottom wall.

In some embodiments, the roller element is removable from the track. In some alternative embodiments, the track is shaped and sized to securely store and maintain the roller element, and the roller element is not removable from the track.

In some embodiments, the two tracks are connected and placed in proximity to or in parallel with each other, by one or more connecting rods between the two trays.

In some embodiments, the connecting rod is removable, movable, bendable, flexible or adjustable, configured to allow the distance between the two trays to be adjustable.

In some further embodiments, the two trays each have an elongated open channel positioned below and in perpendicular to the corresponding track, and the size of the channels are configured to closely receive part of the connecting rod and enable the connecting rod to movably pass though the channels and to connect and maintain the two trays at a desired distance, while allowing adjustment of the distance between the two trays according to distance between the user's two legs while being seated.

Still in some embodiments, the connecting rod is foldable, configured to enable folding of the exercise roller.

In some embodiments, the trays are connected by a foldable frame (e.g., a rectangle foldable frame), the frame being formed by two front rods pivotally connected with one another by a first joint element, two rear rods pivotally connected with one another by a second joint element, and two side rods connecting the respective front and rear rods, and the first and second joint elements configured to allow folding of the frame.

In some embodiments, each of the two trays has a front open channel though which one front rod passes through, and a rear channel through which one rear rod passes through. The front and rear channels in each tray may be in parallel with one another and are positioned in perpendicular to the track of the tray.

In some embodiments, when the frame is unfolded, the two front rods are connected at an angle of about 180 degrees, and the trays are placed in parallel with one another, and are connected by and movable along the front and rear rods, thereby enabling the user to adjust the distance between the two trays and perform knee exercise by using legs to move the roller elements along the tracks of the trays. When the frame is folded downwardly, the bottom surfaces of the two trays are positioned in proximity to or in contact with each other, and the side rods of the frame form a handle element for the user to carry the folded roller.

In some embodiments, the first joint element connecting the two front rods comprises a first elongated element with two ends pivotally attached to the respective two front rods (e.g., through use of hinges), the second joint element connecting the two rear rods comprises a second elongated element with two ends pivotally attached to the respective two rear rods (e.g., through use of hinges), and the lengths of the first and second joint elements are configured to enable the exercise roller to be fully folded. The lengths of the first and second joint elements may be identical.

In some embodiments, the exercise roller further includes a mat for housing the two trays, e.g., onto or within the top surface of the mat.

As used herein, the term “or” is meant to include both “and” and “or.” In other words, the term “or” may also be replaced with “and/or.”

As used herein, the singular forms “a,” “an” and “the” are intended to include the plural forms as well, unless the context clearly indicates otherwise.

As used herein, the spatially relative terms, such as “top”, “bottom”, “inside”, “outside”, “above”, and “under” may be used herein for ease of description to describe one element or feature's relationship to another element(s) or feature(s) as illustrated in the figures. Similarly, the terms “vertical” and “horizontal” and the like are used for the purpose of explanation only unless specifically indicated. The terms are not intended to require the described elements or structures in a specific direction, and are not intended to limit the scope of this invention as such.

### BRIEF DESCRIPTIONS OF THE FIGURES

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 provides a cross-sectional view of an embodiment of a tray included by an exemplary exercise roller according to the present invention.

FIG. 2 provides a top view of the tray of FIG. 1.

FIG. 3 provides a perspective view of the tray of FIG. 1.

FIG. 4 illustrates an exemplary roller element positioned onto the tray of FIG. 1 according to an embodiment of the present invention.

FIG. 5 provides a top view of an embodiment of an exercise roller according to the present invention, with two roller elements positioned onto the two trays.

FIG. 6 provides a perspective view of the exercise roller of FIG. 5.

FIG. 7 provides a further perspective illustration of the exercise roller of FIG. 5, while being used by a user.

FIG. 8 provides a top view of another embodiment of an exercise roller according to the present invention, with a mat housing two trays and two roller elements

FIG. 9 provides a further illustration of the exercise roller of FIG. 8.

FIG. 10 provides a top view of an embodiment of an exercise roller according to the present invention, with two trays connected with each other by a connecting rod.

FIG. 11 provides a further illustration of the exercise roller of FIG. 10, with the distance between the two trays to be adjustable.

FIG. 12 provides a perspective illustration of the exercise roller of FIG. 10, with the two exemplary roller elements positioned onto the trays.

FIG. 13 provides a cross-sectional view of another embodiment of a tray included by an exemplary exercise roller according to the present invention.

FIG. 14 illustrates an exemplary roller positioned within the tray of FIG. 13, according to an embodiment of the present invention.

FIG. 15 provides a top view of another embodiment of an exercise roller according to the present invention, with two roller elements positioned within two trays.

FIG. 16 provides a front view of another embodiment of an exercise roller according to the present invention, with two trays connected by a foldable frame.

FIG. 17 provides a top view of the exercise roller of FIG. 16.

FIG. 18 provides a further top view of the exercise roller of FIG. 16, with the two trays positioned close to each other.

FIG. 19 provides a further illustration of the exercise roller of FIG. 16, at a folded position.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. To the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and other features have not been described in detail as not to unnecessarily obscure aspects of the present exercise roller.

Generally speaking, various embodiments of the present invention provide for an exercise roller having two roller elements movable along corresponding tracks, configured for providing joint (e.g., knee) and leg exercise, as well as foot massage. Particularly, the exercise roller of the present invention may have two trays, each tray having an elongated recessed area on its top surface forming a track configured for closely receiving and maintaining a roller element. In other words, the recessed area forms inner walls of the track. The two trays may be the same as one another. In some embodiments, the tray is preferably made of a solid material, such as a block of wood generally in shape of cuboid. Each track has two ends, and the inner walls constitute a shape or profile suitable for receiving a roller element, which is movable (rollable) along the track between its ends. For instance, the track may have two opposite curved or angled side walls (e.g., with non-slip surfaces) for receiving and contacting the roller element, together with a horizontal bottom wall below and not in contact with the roller element. The roller element can be either removable, or securely stored (and thus not removable) from the track. When the roller element is positioned onto or within the corresponding track, the highest point of the roller element is higher than the top surface of the tray, so as to enable the user's foot to contact part of the roller element above the top surface of the tray. The roller element may be ball shaped, and/or have a dimension suitable for supporting a user's foot. For instance, the roller element may be a ball having a shape of ellipsoid or round sphere. In some embodiments, the ball has a suitable weight for exercise, as well as a hard and relatively smooth surface, thereby providing a sufficiently gentle pressure and massage to the foot during the movement of the ball.

When in use, a user can sit on a chair or couch, and put his or her feet onto the roller elements, and naturally move the legs to move the roller elements back and forth along the corresponding trays for exercise. Importantly, such natural movement allows proper exercise of the user's knees and joints, causes the joint fluid to move around and provides additional nutrients to the joint—without causing any harmful pressure to the joint. In some embodiments, the user may choose roller elements that are specifically shaped and sized to suit the size of the user's feet. In some embodiments, the distance between the two trays may be adjustable. For instance, the two trays can be two separate pieces, which result in easier storage and portability, as well as more flexibility by allowing the user to place the two trays at desired directions or distances based on individual needs. In some further embodiments, the two trays may be connected by connecting element(s) (e.g., one or more connecting rods or frame), while still allowing the distance between the two trays to be adjustable according to individual user's sitting position and/or space between the legs, thereby ensuring the natural movement and proper exercise of the user's knees and legs. Such connecting element(s) may be removable, movable, bendable, flexible, adjustable and/or foldable. Accordingly, the exercise roller according to the present invention not only is easier to be stored or carried, but also provides more flexibility when allowing the user to adjust the distance between the trays to satisfy individual needs.

Accordingly, the exercise roller of this invention provides great benefits to people having poor leg circulation or flexibility, particularly individuals who have insufficient exercise due to, e.g., long periods of sitting at work or home, recovery from knee surgery, or age. The exercise roller of this invention allows the user to easily and naturally move both legs for exercising the joints (without causing harmful pressure to the joints) and improving circulation in legs and feet, while massaging the bottom of the feet to reduce blood clots. The benefits achieved by this invention include, but are not limited to, burning calories and improving leg circulation, providing great knee exercise (e.g., for assisting physical therapy after knee surgery), massaging feet to bring internal organs and systems into a state of optimum functioning, increasing the flexibility of the user's calf and ankle muscles, and providing gentle exercise and massage (which is particularly good for seniors). Further, the exercise roller can be used under a desk, and may fit all kinds of feet (either big or small). The exercise roller is also lightweight, portable, durable, and extremely quite without causing any noise.

Set forth below are several illustrations or examples of apparatus of this invention containing exercise rollers.

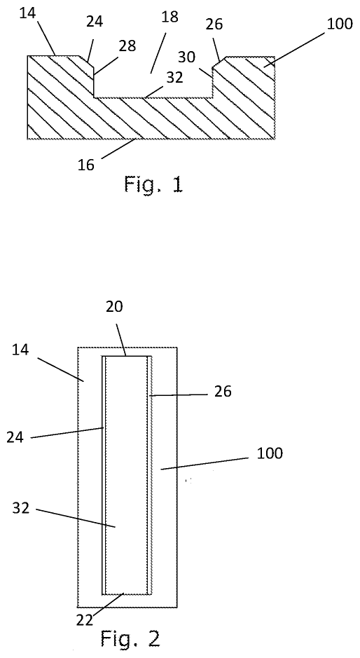

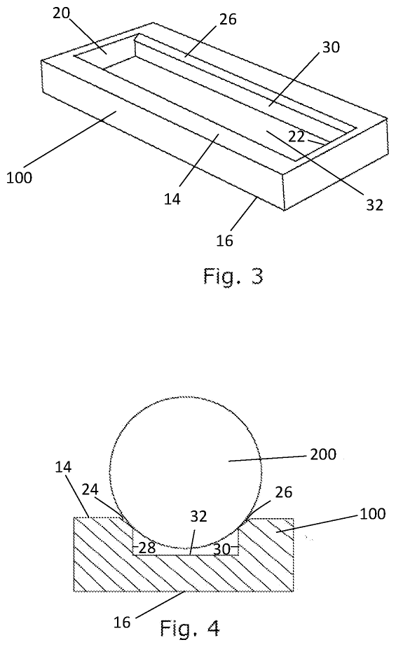

FIGS. 1-3 illustrate tray 100, which may be included by an exercise roller according to the present invention. FIG. 4 further illustrates tray 100 holding roller element 200. As shown in FIGS. 1-4, tray 100 includes top surface 14 and bottom surface 16. Bottom surface 16 may be in contact with a generally flat surface (e.g., a floor), and optionally is non-slip, e.g., by comprising a non-slip material, non-slip pattern, or non-slip pads or tabs (not shown in this figure). Tray 100 is preferably made of a solid material, and may have a shape of cuboid. For instance, tray 100 is can be made of a single-piece, rigid block of wood. Top surface 14 of tray 100 includes a recessed area forming elongated track 18. In particular, when the roller element, e.g., ball 200, is positioned onto or within the track, the highest point of the roller element is higher than top surface 14 of the tray. As such, it would be easier for a user to place his or her foot on the upper part of the roller element being above the top surface of the tray. Track 18 includes inner walls constituting a suitable profile or shape, configured for receiving roller element 200, and allowing roller element 200 to smoothly move along track 18 between its ends 20 and 22. More specifically, track 18 includes two opposite upper side walls 24 and 26 (e.g., being angled as shown in FIG. 1 or otherwise curved, angled, concaved) for receiving roller element 200. Upper side walls 24 and 26 are respectively connected to two opposite straight or vertical lower side walls 28 and 30, which are further connected by generally horizontal and flat bottom wall 32. Roller element 200 may have a shape of ellipsoid or round sphere. When roller element 200 (e.g., in a ball shape) is placed onto track 18, roller element 200 may contact upper side walls 24 and 26, while the lowest point of the roller element may not be in contact bottom wall 32. Roller element 300 can be made of a variety of materials. Preferably, roller element 300 is a stone or wood ball, which provides a suitable weight for exercise, and also has a hard and relatively smooth surface, enabling a gentle pressure and massage onto the foot during the movement of the ball. This is particularly desired for people, such as seniors or patients with injured or diseased joints, who would prefer gentle care and more comfort. Roller element 200 may also be removable from track 100, and thus can be separately stored, carried or combined. This profile provides a stable, while also smooth, movement for rolling a ball shaped roller element. It is to be understood that other profiles may also be provided for inner surface or walls of a track. For instance, the inside walls of the track can have angled, straight, curved, flat profiles or any combination thereof—as long as it enables smooth movement of the corresponding roller element along the track, and provides sufficient massage and exercise functions for the user.

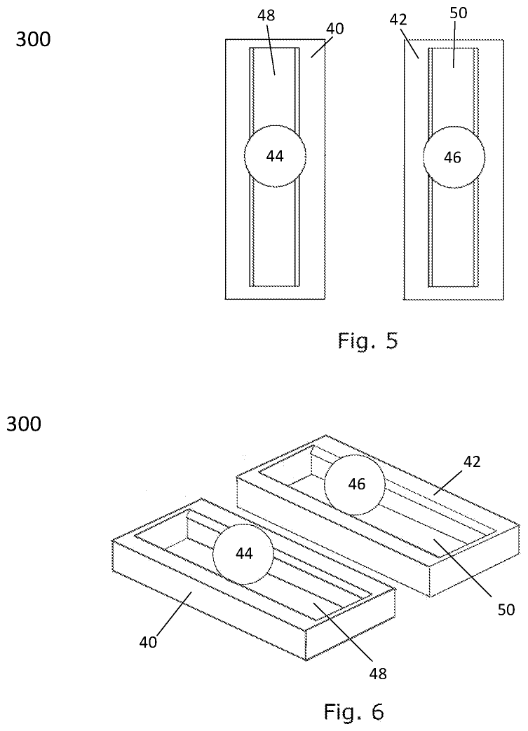

FIGS. 5-6 illustrate exercise roller 300 according to one embodiment of the present invention. Exercise roller 300 includes two trays 40 and 42 each having an elongated track (48, 50), and two roller elements 44 and 46 positioned onto or within the corresponding tracks 48 and 50. Trays 40 and 42 may be identical with each other. For instance, each of trays 40 and 42 may be the same as tray 100 as illustrated in FIGS. 1-4. Roller elements 44 and 46 may also be identical with each other. For instance, each of roller elements 44 and 46 may be the same as ball-shaped roller element 200 as illustrated in FIGS. 1-4. In some embodiments, trays 40 and 42 can be two separate pieces, which result in easier storage and portability, as well as more flexibility by allowing the user to place the two trays at desired directions or distances based on individual needs.

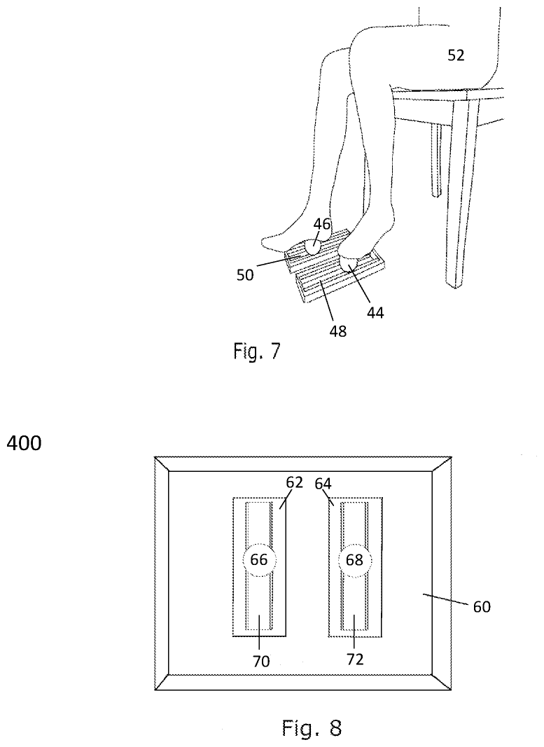

FIG. 7 illustrates exercise roller 300 being used by user 52. In particular, user 52 can sit on a chair or couch, put exercise roller 300 on a floor, use one foot to roll ball 44 along track 48, and use the other foot to roll ball 46 along track 50. In some embodiments, the trays are placed in parallel with each other, and the user may roll the balls in opposite directions. In some other situations, the user may place the two trays at an angled or non-parallel position, and thereby roll the two balls in different directions. When in use, the user may place trays in proximity to each other at desired distance and/or directions, so as to enable the user to naturally roll the balls back and forth, along the corresponding tracks. It is known that, by moving the roller element outside and inside the user's knee, the joint fluid is caused to move around, thereby providing more nutrients to the joint. Accordingly, the exercise roller according to the present invention can provide beneficial movement of joints, without creating pressure to the joints, as well as providing leg exercise and foot massage. This embodiment of a massage roller also provides great flexibility for use and storage, and allows the user to place the two trays at desired distance and/or directions based on individual needs.

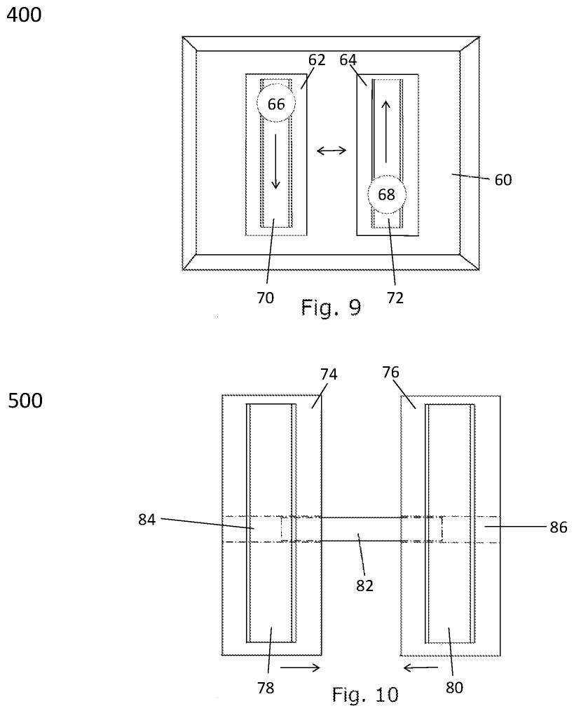

FIGS. 8-9 illustrate exercise roller 400 according to another embodiment of the present invention. Exercise roller 400 includes mat 60 with two parallel trays 62 and 64 joining top surface of exercise roller 400, together with two roller elements 66 and 68 movable along tracks 70 and 72, which are respectively included by trays 62 and 64. For instance, trays 62 and 64 may be the same as tray 100 as illustrated in FIGS. 1-4, and roller elements 66 and 68 may be the same as roller element 200 as illustrated in FIGS. 1-4. As shown in FIGS. 8-9, trays 62 and 64 are placed in parallel with each other at a fixed distance. In some embodiments, mat 60 is made of a different material (e.g., a soft material) than solid trays 62 and 64. As such, exercise roller 400 may be bendable, rollable or foldable for easy storage and carriage.

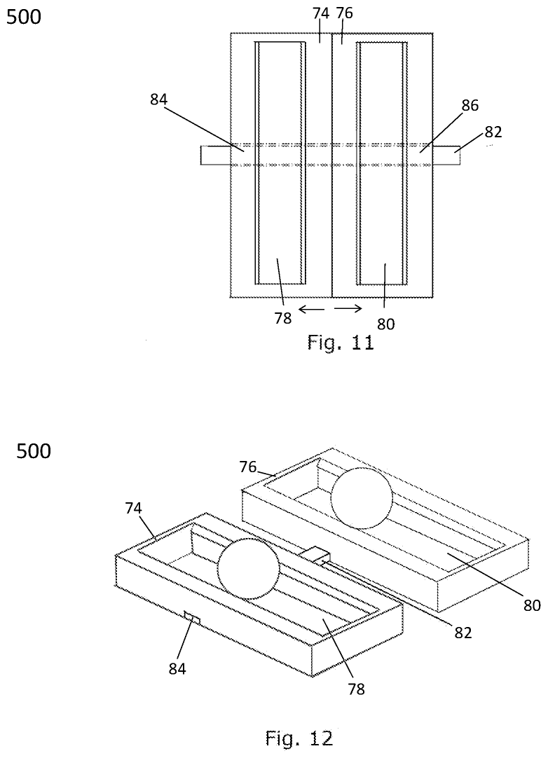

FIGS. 10-12 illustrate exercise roller 500 according to another embodiment of the present invention. Exercise roller 500 includes two trays 74 and 76, each having elongated tracks (78 and 80), as well as roller element 82 and 84 movable along corresponding tracks 78 and 80. Additionally, trays 74 and 76 are connected by connecting rod 82. Trays 74 and 76 each have elongated open channel or passage (84, 86) below and in perpendicular to the direction of tracks 78 and 80. Connecting rod 82 may be removably inserted into, and movably passes through, channels 84 and 86, thereby connecting trays 74 and 76. Accordingly, the distance between the two trays may be adjustable. For instance, a user preferring a narrower distance may place trays 74 and 76 close to each other (e.g., as shown in FIG. 11), while another user preferring a wider distance may place 74 and 76 away from each other (e.g., as shown in FIG. 10). As such, this profile provides a stable and connected configuration, while allowing flexibility of the device to adjust the distance between the two trays according to individual needs. Moreover, in some embodiments, connecting 82 may be removable, and thus makes it easier to use, carry on or store the trays and connecting rods separately. It is to be understood that, while FIG. 12 illustrates a rectangle shape for channels 78 and 80, other profiles or shape may also be provided for channels or connecting rod—as long as it enables necessary connection between the two trays and adjustment of distance between the trays.

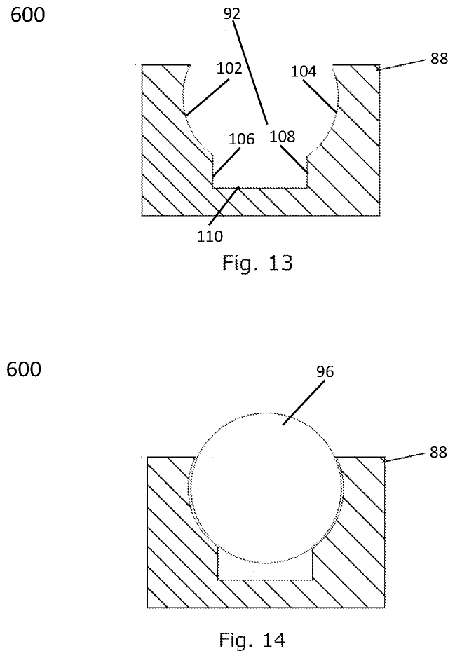

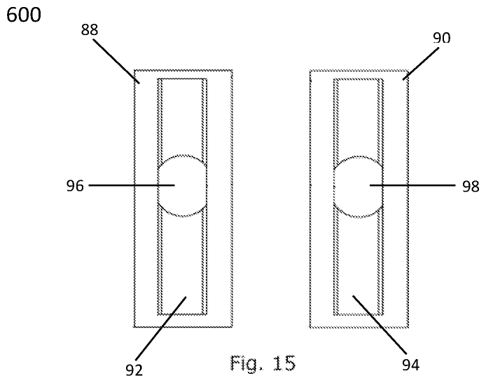

FIGS. 13-15 illustrate another exemplary exercise roller according to the present invention. As shown in FIGS. 13-15, exercise roller 600 includes a pair of trays (88, 90) having respective tracks 92 and 94, together with roller elements 96 and 98 configured to be movable along tracks 92 and 94. More specifically, inner surfaces of track 92 include two opposite side walls 102 and 104, which are curved or otherwise shaped to securely receive, hold or house roller element 96. Upper side walls 102 and 104 are respectively connected to two opposite straight or vertical lower side walls 106 and 108, which are further connected by generally horizontal and flat bottom wall 110. As shown in FIG. 14, roller element 96 may be ball shaped, and are positioned within track 92 by contacting upper side walls 102 and 104 (but not contacting bottom wall 110). The highest point of roller element 96 is still above top surface 112 of the tray, thereby allowing the user to easily put the foot onto ball 96. In this embodiment, roller elements 96 and 98 are securely housed by tracks 92 and 94, and are not removable from tracks 92 and 94. Accordingly, this profile provides an integrated and stable configuration.

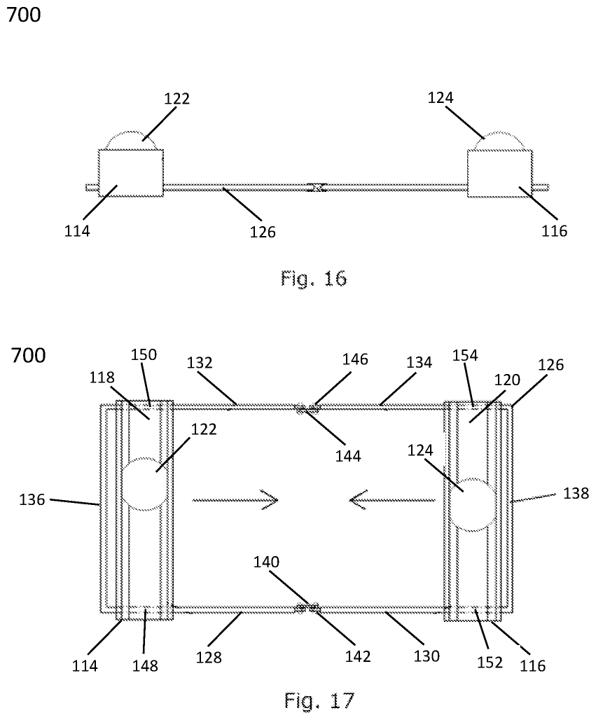

FIGS. 16-19 illustrate a further embodiment according to the present invention. As shown in FIGS. 16-19, exemplary exercise roller 700 includes a pair of trays 114 and 116 having respective tracks 118 and 120, together with roller elements 122 and 124 securely positioned within respective tracks 118 and 120. For instance, tracks 118 and 120 have the same or similar shape as that of track 92 (as shown in FIGS. 13-14); and roller elements 122 and 124 have the same or similar shape as that of roller element 96 (as shown in FIGS. 13-14). Trays 114 and 116 are connected by a foldable frame 126 (e.g., with a rectangle or otherwise suitable shape), which further includes front rods 128 and 130, rear rods 132 and 134, side rode 136 connecting front rod 128 and rear rod 132, and side rod 138 connecting front rod 130 and rear rod 134. Front rods 128 and 130 are pivotally connected with each other by joint element 140, which further includes elongated element 142 pivotally attached to front rods 128 and 130 (e.g., by use of hinges) at a central location between trays 114 and 116. Similarly, rear rods 132 and 134 are pivotally connected with each other by joint element 144, which further includes elongated element 146 pivotally attached to rear rods 132 and 134 (e.g., by use of hinges) between trays 114 and 116. As such, frame 126 is foldable, through rotation movement of front rods 128 and 130 relative to joint element 140, and rotation movement of rear rods 132 and 134 relative to joint element 144. Tray 114 includes front open channel 148 through which front rod 128 passes, and rear open channel 150 through which rear rod 132 passes through. Similarly, tray 116 includes front open channel 152 through which front rod 130 passes through, and rear open channel 154 through which rear rod 134 passes through. Channels 148, 150, 152, and 154 are all extended in directions in perpendicular to elongated tracks 118 and 120.

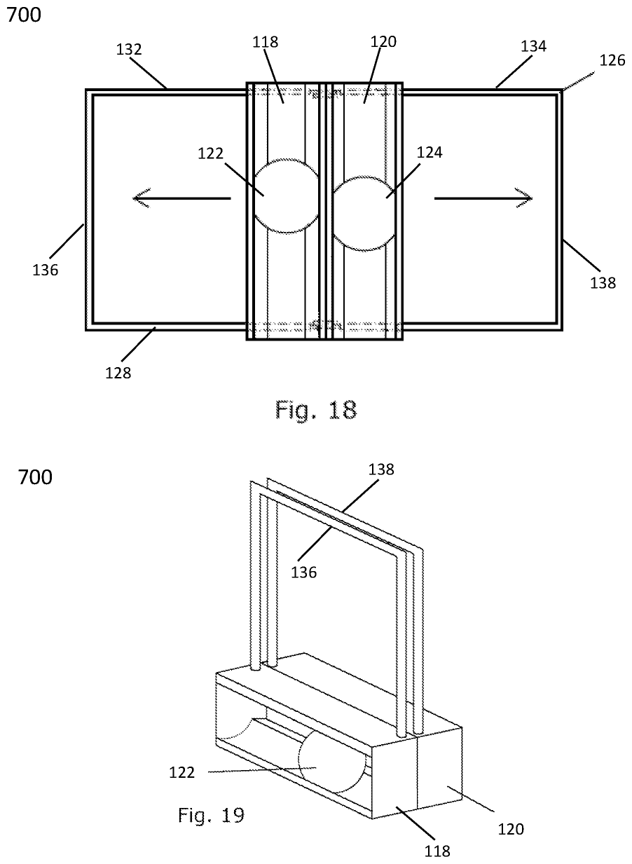

As shown in FIGS. 16-18, when frame 126 is at an unfolded or open position, front rods 128 and 130 (as well as rear rods 132 and 134) are connected at an angle of about 180 degrees, so that trays 114 and 116 can be placed in parallel on a planer surface (e.g., surface) for use. As shown in FIGS. 17-18, trays 114 and 116 are movable along the front and rear rods, and thus the distance between trays 114 and 116 can be adjustable according to individual needs. Further, as shown in FIG. 19, when the frame is folded (downwardly), trays 114 and 116 are positioned in proximity to or in contact each other (e.g., with their bottom surfaces contacting with each other). Side rods 136 and 138 may form a handle element for the user to carry the folded exercise roller. In this profile, the length of joint elements 142 and 144 are configured to allow exercise roller 700 to be fully folded (e.g., with the bottom surface of tray 114 closely and fully in contact with the bottom surface of tray 116). Moreover, since roller elements 122 and 124 may be securely held within respective tracks 118 and 120, they will not fall off even when exercise roller 100 is at a folded position. Accordingly, this foldable configuration provides a convenient, portable device that can be easily carried and stored.

The exercise rollers according to the present invention are able to provide the user (particularly senior people and patients with injured or diseased joints) with proper, effective and convenient exercise and rehabilitative therapy. Specifically, the exercise rollers according to the present invention allow the user to easily and naturally move both legs for exercising the joints (without causing harmful pressure to the joints) and improving circulation in legs and feet, while massaging the bottom of the feet to reduce blood clots. Table 1 below provides an example showing significantly improved knee conditions of a patient who had used, as experiment, an exercise roller of this invention.

TABLE 1

| Date | Test Results | |
|---|---|---|
| First Time | The patient had the following test results when | |
| Using the | having knee surgery: | |
| Roller | 1. | There is a bucket-handle tear of the medical |
| | | meniscus with displaced meniscal tissue in the |
| | | intercondylar notch |
| | 2. | Large joint effusion |
| | 3. | Minimal chondromalacia of the medical and lateral |
| | | femoral tibial compartments without high grade |
| | | articular cartilage loss |
| Two Years | The same patient had the following test results: | |
| after the First | 1. | Slight lateral patellar tilt |
| Use of the | 2. | Moderate loss of the medical clear space to both |
| Roller | | knees |
| Eight Years | The same patient had the following test results: | |
| and Ten | 1. | No acute fractures or osseous lesions |
| Months after | 2. | Patellar femoral relationship is within normal limits |
| the First Use | 3. | No significant joint effusion. |
| | 4. | Mild osteoarthritic changes |

As shown above, the patent had used the exercise roller of this invention (e.g., as shown in FIG. 7) to exercise her knees after the knee surgery. Since the first time using an exercise roller of this invention, the patient had used it for about 5 times each week and about an average of 20˜30 minutes each time. As the exercise roller of this invention can provide proper knee exercise and joint movement without causing harmful pressure to the joint during exercise, the patient's severe knee problems (e.g., joint effusion; tear; loss of clear space) had significantly improved or recovered over a test period of 2-8 years. The longer the use period, the more significant the improvement in the knee conditions. Such significant improvement showed the great exercise and rehabilitative benefits achieved by the exercise rollers of the present invention.

Although specific embodiments of this invention have been illustrated herein, it will be appreciated by those skilled in the art that any modifications and variations can be made without departing from the spirit of the invention. The examples and illustrations above are not intended to limit the scope of this invention. Any combination of embodiments of this invention, along with any obvious their extension or analogs, are within the scope of this invention. Further, it is intended that this invention encompass any arrangement, which is calculated to achieve that same purpose, and all such variations and modifications as fall within the scope of the appended claims.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example of a generic series of equivalent or similar features.

### Other Embodiments

It is to be understood that while the invention has been described in conjunction with the detailed description thereof and accompanying figures, the foregoing description and accompanying figures are only intended to illustrate, and not limit the scope of the invention, which is defined by the scope of the appended claims. Other aspects, advantages, and modifications are within the scope of the following claims. All publications referenced herein are incorporated by reference in their entireties.

What is claimed is:

1. An exercise roller comprising
two opposite, generally horizontal planar trays, each tray having a bottom surface and a top surface, the top surface of each tray comprising an elongated recessed area forming a track configured for closely receiving and maintaining a roller element, each track having two ends; and
two roller elements, sized and configured to be independently and respectively movable along the two tracks between their respective ends,
wherein the size of the roller element and the length and width of the tray are configured to enable a user to perform knee exercise and receive foot massage while being seated, by using the user's two legs to move the roller elements, one by each foot, back and forth along the respective corresponding tracks.

2. The exercise roller of claim 1, wherein the two roller elements are identically sized.

3. The exercise roller of claim 1, wherein the roller element is a ball having an ellipsoid or round shape.

4. The exercise roller of claim 1, wherein the roller element has a generally smooth and hard surface, to provide gentle massage to the user's foot during movement.

5. The exercise roller of claim 1, wherein the roller element is made of plastic, stone, wood, or metal.

6. The exercise roller of claim 1, wherein when the roller element is positioned onto or within the corresponding track, the highest point of the roller element is higher than the top surface of the tray, so as to enable the user's foot to contact part of the roller element above the top surface of the tray.

7. The exercise roller of claim 1, wherein the track has a curved or grooved inner surface.

8. The exercise roller of claim 7, wherein the track has opposite curved, grooved, angled, or vertical side walls, and a generally horizontal bottom wall.

9. The exercise roller of claim 8, wherein the track has two opposite curved or angled upper side walls, respectively connecting to two opposite vertical lower side walls, connected by the horizontal bottom wall; wherein the upper side walls are configured to closely receive the roller element and enable the roller element to contact and move along the upper side walls without contacting the horizontal bottom wall.

10. The exercise roller of claim 1, wherein the roller element is removable from the track.

11. The exercise roller of claim 1, wherein the track is shaped and sized to securely store and maintain the roller element, and the roller element is not removable from the track.

12. The exercise roller of claim 1, wherein the two tracks are connected and placed in proximity to or in parallel with each other, by one or more connecting rods between the two trays.

13. The exercise roller of claim 11, wherein the connecting rod is removable, movable, bendable, flexible or adjustable, configured to allow the distance between the two trays to be adjustable.

14. The exercise roller of claim 13, wherein the two trays each have an elongated open channel positioned below and in perpendicular to the corresponding track, and the size of the channels are configured to closely receive part of the connecting rod and enable the connecting rod to movably pass through the channels and to connect and maintain the two trays at a desired distance, while allowing adjustment of the distance between the two trays according to distance between the user's two legs while being seated.

15. The exercise roller of claim 11, wherein the connecting rod is foldable, configured to enable folding of the exercise roller.

16. The exercise roller of claim 15, wherein the trays are connected by a foldable frame, the frame being formed by two front rods pivotally connected with one another by a first joint element, two rear rods pivotally connected with one another by a second joint element, and two side rods connecting the respective front and rear rods, and the first and second joint elements configured to allow folding of the frame.

17. The exercise roller of claim 16, wherein each of the two trays has a front open channel though which one front rod passes through, and a rear channel through which one rear rod passes through, and wherein the front and rear channels in each tray are in parallel with one another and are positioned in perpendicular to the track of the tray.

18. The exercise roller of claim 17, wherein when the frame is unfolded, the two front rods are connected at an angle of about 180 degrees, and the trays are placed in parallel with one another, and are connected by and movable along the front and rear rods, thereby enabling the user to adjust the distance between the two trays and perform knee exercise by using legs to move the roller elements along the tracks of the trays;
when the frame is folded downwardly, the bottom surfaces of the two trays are positioned in proximity to or in contact with each other, and the side rods of the frame form a handle element for the user to carry the folded roller.

19. The exercise roller of claim 16, wherein the first joint element connecting the two front rods comprises a first elongated element with two ends pivotally attached to the respective two front rods, the second joint element connecting the two rear rods comprises a second elongated element with two ends pivotally attached to the respective two rear rods, and the lengths of the first and second joint elements are configured to enable the exercise roller to be fully folded.

20. The exercise roller of claim 1, further comprising a mat for housing the two trays.
